(19) United States
(12) Patent Application Publication
(10) Pub. No.: US 2004/0062488 A1
(43) Pub. Date: Apr. 1, 2004

(54) Fiber optic adapter sleeve

(76) Inventor: Charles Wood, Eden Prairie, MN (US)

Correspondence Address: MERCHANT & GOULD PC, P.O. BOX 2903, MINNEAPOLIS, MN, 55402-0903, US

(21) Appl. No.: 10/259,096

(22) Filed: Sep. 26, 2002

(51) Int. Cl. G02B 6/38

(52) U.S. Cl. 385/70

(57) ABSTRACT

An adapter sleeve that is configured to coaxially align a first telecommunications ferrule/hub assembly with a second telecommunications ferrule/hub assembly within an adapter. The adapter sleeve includes a continuous, non-split body. In the preferred embodiment, the adapter sleeve has a square configuration. The adapter sleeve is configured to align cable assemblies having connectors of varying size.

### TECHNICAL FIELD

This disclosure relates generally to devices and methods of use relating to fiber optic cables. More particularly, this disclosure relates to an adapter sleeve for use with telecommunication adapters that align two fiber optic cables.

### BACKGROUND

A wide variety of arrangements have been utilized for mating telecommunication fiber optic cables. With the increased use of fiber optics, it is becoming more important to be able to accurately and reliably connect and disconnect fiber optic cables from various sources. Fiber optic cables are commonly coupled in communication with one another by using well-known SC, ST, or FC-type connectors. The connectors are typically secured within an adapter configured to place each fiber optic cable in communications with the other. The adapter has typically two openings, each one designed to receive a particular type connector. The adapter is usually fixed to a panel or other holder.

U.S. Pat. No. 5,317,663 concerns an adapter for receiving two SC-type connectors. Another adapter configuration is disclosed in U.S. Pat. No. 6,347,888 concerning adapters which permit joining of different types of connectors. Adapters, such as those described in U.S. Pat. Nos. 5,317,663, 6,142,676, and 6,347,888 have a cylindrical split sleeve to align the connectors, and in turn, align the optic fibers of the cables. There is a need for improving the accuracy and reliability in aligning such fiber optic components, and for improving alignment accuracy between connectors of varying size. There is further a need for reducing costs associated with manufacture and assembly of such adapter assemblies.

### SUMMARY

According to a preferred embodiment of the present disclosure, an adapter is provided for holding a first fiber optic connector and second fiber optic connector in coaxial alignment. The adapter includes a main body having a cavity extending between first and second ends along an axial direction and a first mating arrangement positioned at the first end of the main body, and a second mating arrangement positioned at the second end of the main body. The adapter further includes a sleeve including planar surfaces and having a longitudinal axis aligned with the axial direction of the main body to align the first and second fiber optic connectors when held by the adapter. Preferably, the sleeve defines a square cross-section.

The present disclosure also relates to a method of aligning at least a first fiber optic connector along a longitudinal axis of an adapter sleeve and adapter, and a method of making an adapter sleeve and adapter for use in holding a first fiber optic connector and second fiber optic connector in alignment.

### BRIEF DESCRIPTION OF THE DRAWINGS

FIG. 1 is a side elevational view of a prior art cylindrical split sleeve of an adapter mated with a fiber optic ferrule of a connector;

FIG. 2 is a front elevational view of the split sleeve and ferrule of FIG. 1;

FIG. 3. is a perspective view of an adapter in accordance with the principles disclosed;

FIG. 4 is a perspective view of an SC type connector that can be used in accordance with the principles disclosed;

FIG. 5 is a perspective view of an ST type connector that can be used in accordance with the principles disclosed;

FIG. 6 is a perspective view of an FC type connector that can be used in accordance with the principles disclosed;

FIG. 7 is an exploded assembly view of the adapter of FIG. 3;

FIG. 8 is an exploded assembly view of the adapter of FIG. 3, showing an alternative connector mounting arrangement;

FIG. 9 is a front perspective view of an adapter portion and ferrule/hub assembly, shown with one embodiment of a sleeve according to the principles disclosed;

FIG. 10 is a cross-sectional view of FIG. 9, taken along line 10-10;

FIG. 11 is a side elevational view of the sleeve and ferrule/hub assembly of FIG. 9;

FIG. 12 is a front elevational view of the sleeve and ferrule/hub assembly of FIG. 11;

FIG. 13 is a front elevational view of the sleeve of FIG. 12;

FIG. 14 is a cross-sectional view of the sleeve shown in FIG. 11 having two different ferrule assemblies inserted therein;

FIG. 15 is a side perspective view of an alternative embodiment of a sleeve according to the principles disclosed;

FIG. 16 is a side perspective view of the sleeve of FIG. 15, shown with a ferrule/hub assembly inserted therein;

FIG. 17 is a front elevational view of the sleeve of FIG. 15;

FIG. 18 is a cross-sectional view of FIG. 16, taken along line 18-18;

FIG. 19 is a side perspective view of the sleeve of FIG. 16, shown with a second ferrule/hub assembly inserted therein; and

FIG. 20 is a cross-sectional view of FIG. 19, taken along line 20-20.

### DETAILED DESCRIPTION

With reference now to the various figures in which identical elements are numbered identically throughout, a description of various exemplary aspects of the present invention will now be provided.

The present disclosure generally relates to an adapter assembly having a sleeve that improves alignment between fiber optic cables. The fiber optic cables each terminated with a connector that is inserted within the adapter to provide communication between the optic fibers of the cables.

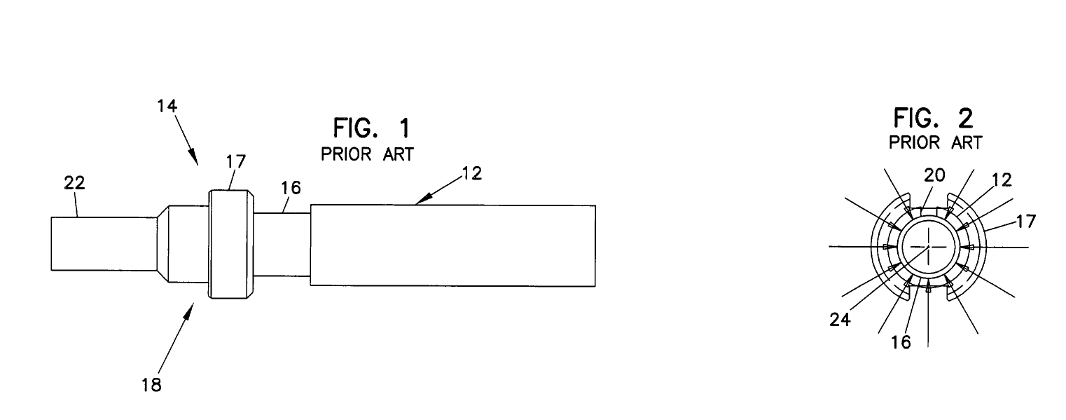

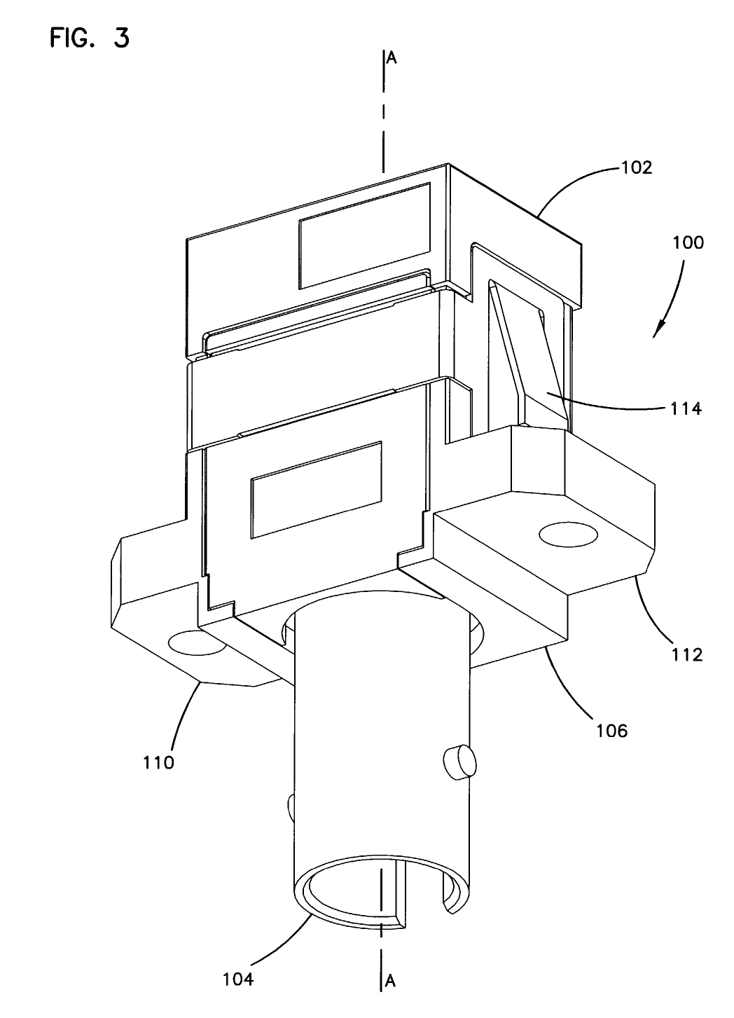

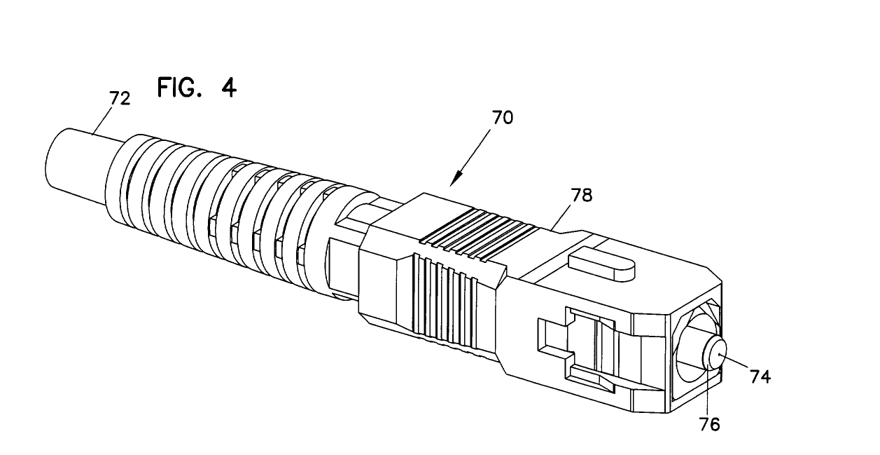

Conventional adapter devices use cylindrical split sleeves to couple the two joining cables. FIGS. 1 and 2 illustrate a cylindrical split sleeve 12 commonly known in the telecommunications industry. A cable assembly 14 of a terminated cable is shown inserted within one end of the cylindrical split sleeve 12. The cable assembly 14 generally includes a fiber optic cable 22 coupled to a ferrule 16 of a ferrule/hub assembly 18. The ferrule 16 is held by a hub 17 of the ferrule/hub assembly 18. The remainder of the connector is not shown in FIGS. 1 and 2. Further details of example connectors are shown in FIGS. 4-6.

As best shown in FIG. 2, the cylindrical sleeve 12 includes a split 20 that runs along the longitudinal dimension of the sleeve. The cylindrical sleeve 12 exerts radial forces (represented by arrows) on the ferrule 16 to center and align an optic fiber 24 of the cable assembly 14 with a second optic fiber (not shown) of a second cable assembly (not shown) inserted within the opposite end of the cylindrical sleeve.

As illustrated by the arrows in FIG. 2, the radial forces of the cylindrical split sleeve 12 are asymmetric and decrease near the split 20. In other words, the forces acting to centrally align the optic fibers are non-uniform about the ferrule's circumference. The variance in radial force can cause misalignment between cable assemblies. This configuration also poses problems in assembly wherein orientation of the slot can be critical. For example, if the slot is oriented such that a user is likely to bend the connector in a direction toward the slot, the slot may further distort and cause greater misalignment. Another misalignment problem caused by the cylindrical split sleeve 12 occurs from geometric variations in the split 20, and thus in radial forces, when connectors having different diameters are inserted within each end of the sleeve 17.

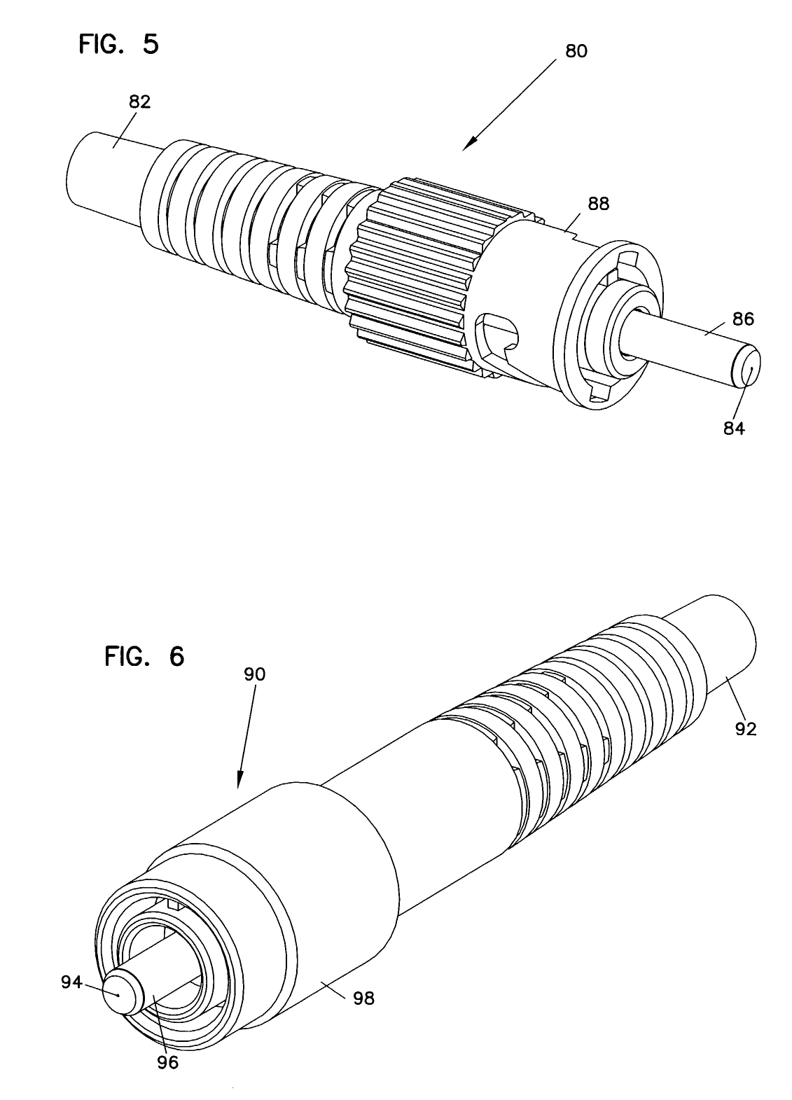

FIG. 3 illustrates one embodiment of an adapter 100 for use with an improved sleeve in accordance with the principles disclosed. Each end 102, 104 of the adapter 100 receives a fiber optic connector. The first end 102 of the illustrated embodiment is configured to receive an SC-type connector. An exemplary SC connector 70 is shown in FIG. 4. The second opposite end 104 of the adapter 100 is configured to receive an ST-type connector. FIG. 5 shows an exemplary ST connector 80. The adapter 100 may also be configured to receive an FC-type connector to provide communication between the FC-type connector and either a ST type connector or SC type connector. An exemplary FC connector 90 is shown in FIG. 6.

Referring to FIG. 4, the SC-type connector 70 includes a cable 72 containing an optic fiber 74 that is held at the end by a ferrule 76. The ferrule 76 is held by a connector housing 78. The ST-type connector 80, shown in FIG. 5, similarly includes a ferrule 86 that holds an optic fiber 84 of a cable 82. The ferrule 86 is held by a housing 88. Likewise, the FC-type connector 90, shown in FIG. 6, includes a ferrule 96 that holds an optic fiber 94 of a cable 92. The ferrule 96 is held by a housing 98.

Referring again to FIG. 3, the illustrated adapter 100 includes a unitary main body 106 having a central axis A-A. The connectors of fiber optic cable assemblies are inserted within each of the ends 102, 104 to coaxially align the optic fibers of the cable assemblies with axis A-A. In the illustrated embodiment, the adapter 100 includes outwardly extending tabs 110, 112 and retaining clips 114 to permit mounting to a panel. Various mounting structures and configurations to mount and retain an adapter to a panel, a wall or other holder can be used.

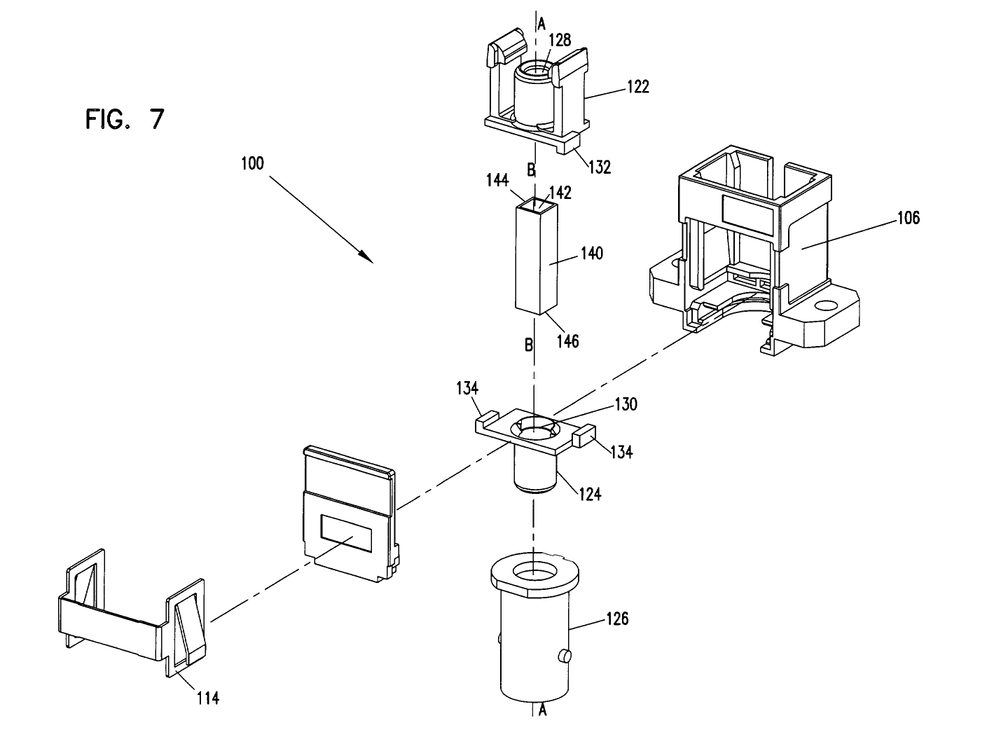

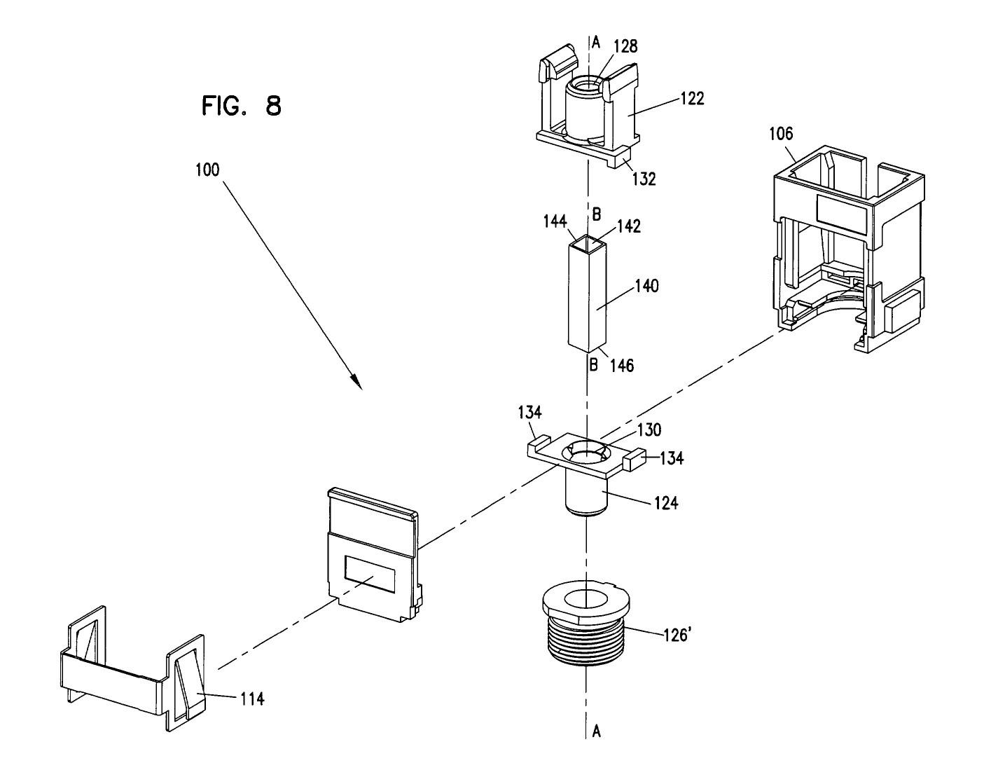

Referring now to FIG. 7, the adapter 100 is illustrated in an exploded assembly view. In the illustrated embodiment, the adapter 100 includes a plurality of mating components including a first mating component 122, a second mating component 124, and a third mating component 126. The first and second mating components 122, 124 form mating halves that receive the ferrules of two connectors. In the illustrated embodiment, the first mating component 122 defines an SC mating component for mating with an SC-type connector, like the SC connector 70 of FIG. 49. The second mating component 124 and third mating component 126 define an ST mating component for mating with an ST-type connector, like the ST connector 80 of FIG. 5. As shown in FIG. 8, the second mating component 124 and an alternative third mating component 126′ of the adapter 100 may be used to receive an FC-type connector, like the FC connector of FIG. 6. The adapter can also be of the type where both ends are configured for receipt of the same connector type. The housings and internal components of the adapter, with the exception of an improved sleeve 140 of the present invention, can be made in accordance with the adapters of U.S. Pat. Nos. 5,317,663, 6,142,676, and 6,347,888, the disclosures of which are incorporated herein by references. As can be understood, the adapter may be configured with a variety of connector mounting arrangements for use in different telecommunication applications.

As shown in FIGS. 7 and 8, the first mating component 122 and the second mating component 124 each include an axial aperture 128, 130. The first and second mating components 122, 124 are arranged such that the flanges 132, 134 abut one another, and the axial apertures 128, 130 extend in opposite directions. The axial apertures 128, 130 are configured to receive a sleeve 140. The illustrated preferred sleeve is square. In use, the adapter 100 receives a first connector (70, 80, 90) within the first end 102 and a second connector (70, 80, 90) within the second end 104, and securely holds the two connectors in coaxial alignment for signal transmission between the connectors. In particular, the axial aperture 128 and the first end 144 of the sleeve 140 receives the ferrule (76, 86, 96) of the first connector. The axial aperture 130 and the second opposite end 146 of the sleeve 140 receives the ferrule (76, 86, 96) of the second connector. The axial apertures 128, 130 and the sleeve 140 form a ferrule holding arrangement for holding an end of the ferrule of each connector mounted to the adapter 100.

The preferred embodiment of the sleeve 140 includes a plurality of planar walls 148, each of the walls having planar surfaces. The plurality of planar walls can include any number of planar walls configured to receive the ferrule of the ferrule/hub assembly 160. For example, the sleeve may have three planar walls configured in a triangular arrangement, or have a polygonal arrangement of five or more planar walls.

The sleeve 140 of the illustrated embodiment has a symmetrical square cross-section (FIG. 13). In particular, the sleeve 140 includes four planar sides or side wall structures 148, each having a uniform width and length. A first side wall 171 and an opposite second side wall 172 are joined by a third side wall 173 and a fourth side wall 174 opposite the third side wall 173. In the preferred embodiment, the third and fourth side walls 173, 174 are generally perpendicular to the first and second side walls 171, 172 to form a symmetrical sleeve structure having the shape of a square. The walls 171-174 define a central passage 142 that extends between a first end 144 and a second end 146 of the sleeve 140. The central passage 142 has a longitudinal axis B-B that coaxially aligns with axis A-A of the adapter 100. Each of the planar sides or side wall structures 148 extends parallel to the longitudinal axis B-B of the sleeve 140.

The planar side walls 171-174 from a continuous sleeve body 180. What is meant by continuous sleeve body is that the body of the sleeve is non-split or non-slotted along the sleeve's length. The body 180 also has a solid wall structure portion 182 that receives the ferrule of the cable connectors at each of the ends 144, 146 of the sleeve (see FIGS. 11 and 15).

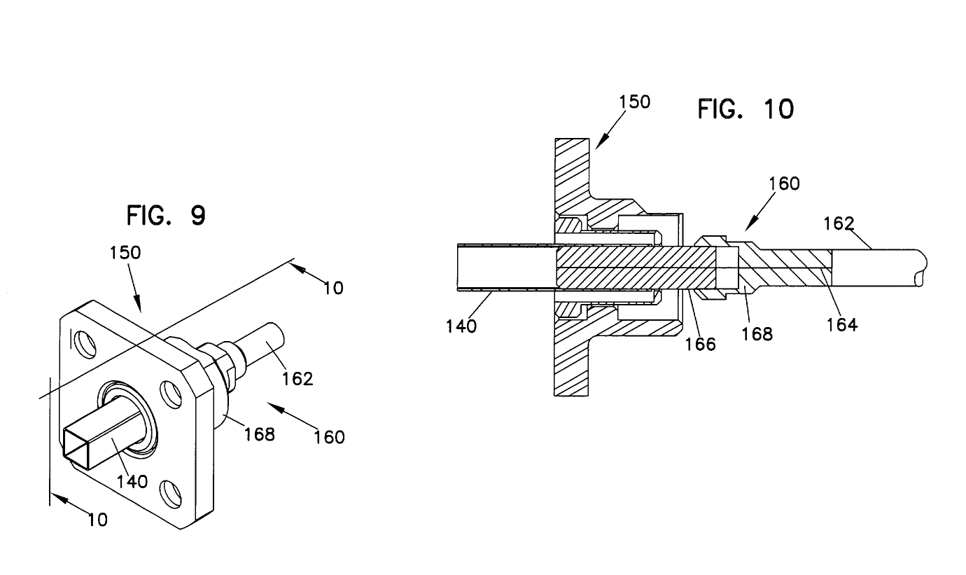

Referring now to FIGS. 9 and 10, the square sleeve 140 is illustrated with a schematic representation of an adapter portion 150 and a ferrule/hub assembly 160. The adapter portion 150 can include each of the mating component 122, 124, 126, and 126′ embodiments previously described. The adapter portion 150 may further including other components configure for receipt of connectors and the square sleeve 140 in accordance with the principles disclosed. The ferrule/hub assembly 160 can include each of the SC, ST, and FC type connectors 70, 80, 90 previously described or other connector types. The ferrule/hub assembly 160 will be hereinafter schematically represented as including a cable 162 having an optic fiber 164 (FIG. 10), mounted to a ferrule 166 (FIG. 10), and a hub 168.

Referring now to FIGS. 11-13, the illustrated sleeve 140 has a square tubular configuration defining the central passage 142. The central passage 142 correspondingly has a square configuration. The passage 142 is sized to receive the ferrule 166 of the ferrule/hub assembly 160 within one of the open ends 144, 146. A second ferrule (not shown) may be inserted into the other of the open ends 144, 146.

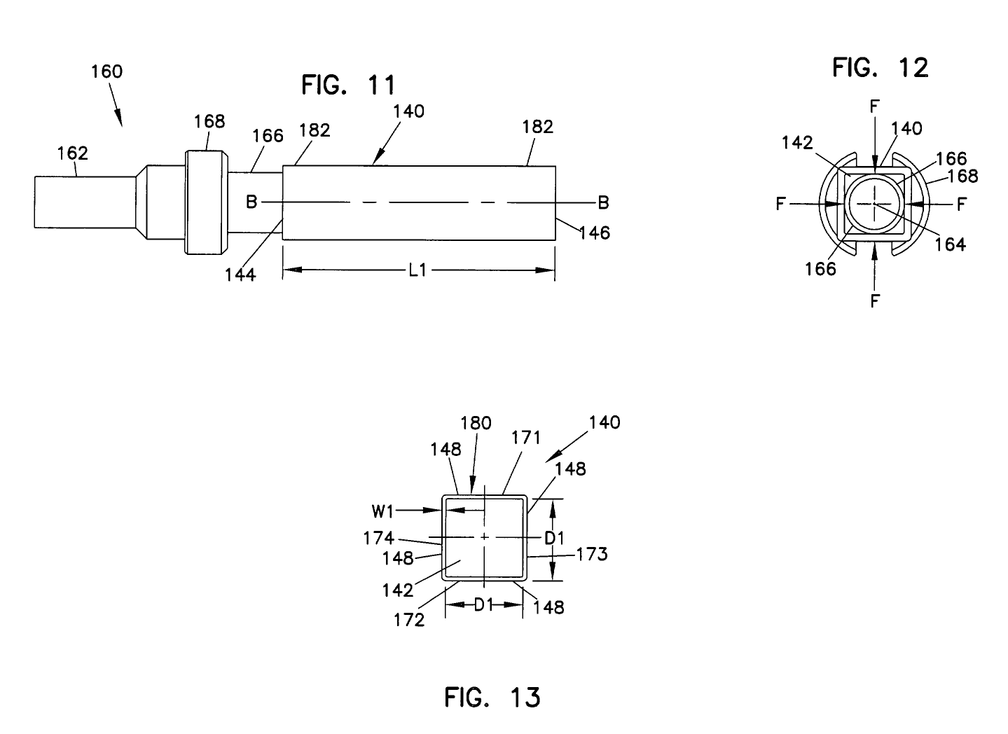

The square configuration of the sleeve 140 is designed such that the ferrule/hub assembly 160 is centered within the passage 142 of the sleeve. In particular, the sleeve 140 is configured to align the optic fiber 164 of the ferrule/hub assembly 160 along the longitudinal axis B-B of the sleeve 140. As show in FIG. 12, the square sleeve 140 exerts forces F (represented by arrows) equally around the circumference of the ferrule 166. That is, each side 148 exerts a force in a direction toward the longitudinal axis B-B, to align the ferrule 166, and thus the optic fiber 164, along the longitudinal axis B-B of the sleeve 140.

The sleeve 140 is design to provide equal centering forces F to properly align the optic fiber along the axis B-B. Each of the forces F created by the side walls 171-174 of the sleeve 140 are of substantially the same magnitude. As will be discussed in greater detail, the forces are created by deformation or bulging or expansion of the sleeve's side walls. In accord with the principles disclosed, the side walls are constructed to uniformly deform relative to one another and provide substantially equal forces. In the preferred embodiment, a square shape provides forces that act in a direction opposite, or in opposition to, another force. As can be seen, the configuration of the sleeve 140 provides a line contact along each of the planar side walls 171-174. In other words, the sleeve 140 contacts the ferrule of a ferrule/hub assembly along a line extending the length of the ferrule. In the embodiment having a square configuration, the line contact of one of the side walls, e.g. 171, is aligned with, and opposed to, the line contact of an opposed side wall, e.g. 172.

The lines of contact are preferably approximately evenly spaced about the circumference of the ferrule. In the illustrated embodiment having four planar walls, four lines of contact equally spaced at approximately 90-degree intervals about the circumference of the ferrule are provided. Because the centering forces-along the line contacts are equal in magnitude, and uniformly distributed to act upon the ferrule/hub assembly, the optic fiber 164 is properly center within the sleeve 140, and thus within the adapter (100).

Referring still to FIGS. 11 and 13, the square sleeve 140 has a length L1, a side wall dimension D1, and a wall thickness W1. The length L1 is preferably in the range of 0.25 inches and 0.75 inches; more preferably the length L1 is about 0.50 inches. The side wall dimension D1 is preferably in the range of 0.050 inches and 0.125 inches; more preferably the side wall dimension D1 is about 0.1 inch. The wall thickness W1 of the sleeve 140 is preferably in the range of 0.003 inches and 0.015 inches; more preferably the wall thickness W1 is about 0.005 to 0.012 inches.

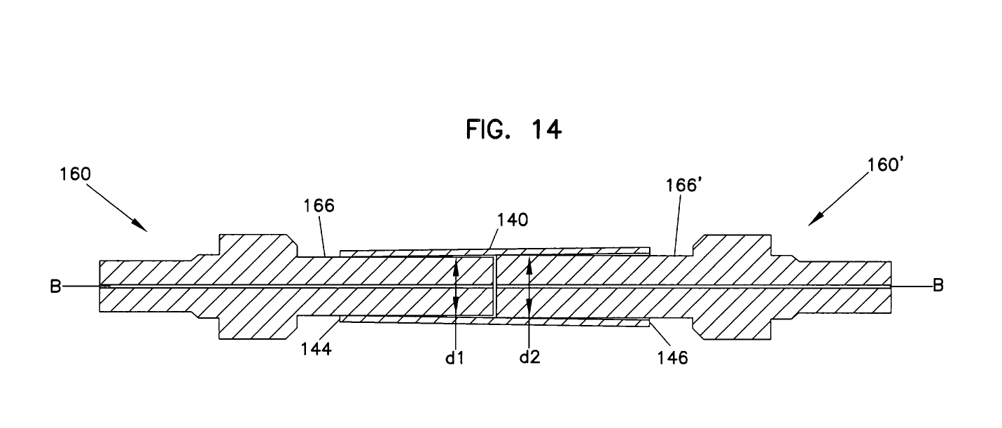

In FIG. 14, the sleeve 140 is shown assembled with a first ferrule/hub assembly 160 inserted within the first end 144 of the sleeve 140 and a second ferrule/hub assembly 160′ inserted within the second end 146 of the sleeve. As can be seen, the first ferrule/hub assembly 160 has a ferrule 164 having a first dimension d1. The second ferrule/hub assembly 160′ has a ferrule 164′ having a second dimension d2. The first dimension d1 is different than the first dimension d2.

In accordance with the principles disclosed, the square sleeve 140 is configured to accommodate ferrules of differing sizes and dimensions. The forces at each end of the sleeve 140 remain equal and opposite at each end 144, 146 of the sleeve 140 regardless of the ferrules dimension d1, d2 or diameter. In particular, the side walls of the sleeve 140 at the first end 144 provide equal and opposite forces to center the ferrule 166 of the ferrule/hub assembly 160 along the longitudinal axis B-B of the sleeve 140. Likewise, the side walls of the sleeve 140 at the second end 144 provide equal and opposite forces to center the second ferrule 166′ of the second ferrule/hub assembly 160′ along the longitudinal axis B-B of the sleeve 140. By this, the square sleeve centers or aligns each of the optic fibers of the cable assemblies 160, 160′ along the longitudinal axis B-B of the sleeve, and thereby aligns the optic fiber of the first ferrule/hub assembly 160 with the optic fiber of the second ferrule/hub assembly 160′.

Referring now to FIG. 15, a second alternative embodiment of the square sleeve 140 is shown. In this embodiment, the sleeve 140 includes an opening 134 located approximately halfway along the length L1 of the sleeve 140. The opening 134 in the illustrated embodiment is shown to be configured within each of the sides 148 of the sleeve. It is contemplated that fewer sides may be configured with the opening. Further, it is contemplated that more openings may be configured within a particular side.

The opening 134 provides a stress relief region to accommodate stress created by insertion of the cable assemblies having ferrules of either the same size or different sizes. In particular, the sleeve is configured to provide a slight interference fit, or line contact as previously discussed, between the interior of the central passage 142 and the ferrule of the ferrule/hub assembly. The interference fit ensures proper contact between the ferrule and each of the sides 148 of the sleeve 140 to center or align the ferrule/hub assembly. The interference fit also assists in retaining the ferrule/hub assembly within the adapter.

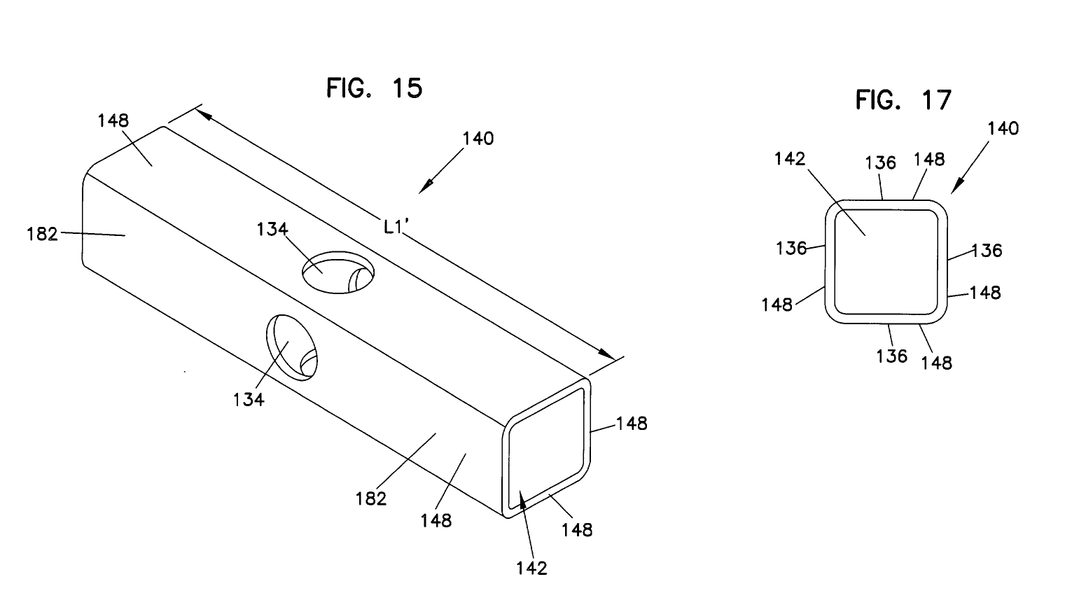

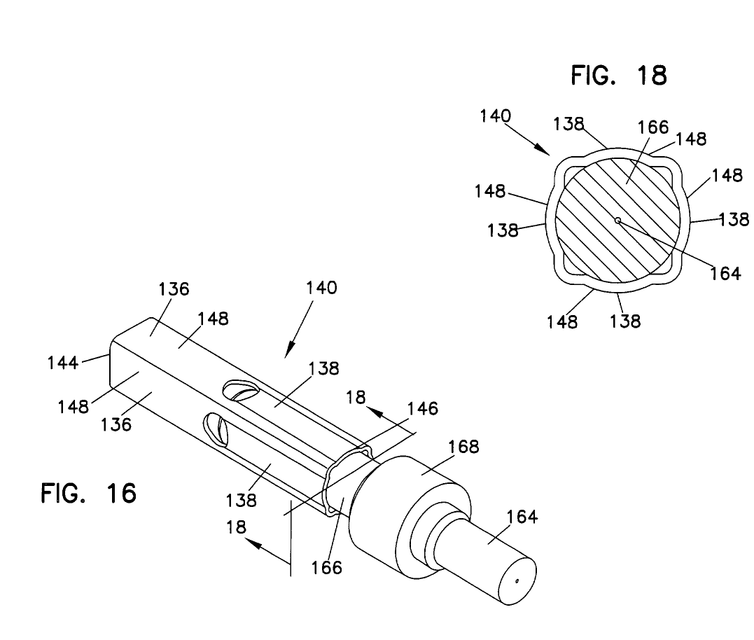

As can be seen in FIG. 16, when a ferrule/hub assembly 160 is inserted within the sleeve 140, the interference fit between the ferrule 166 and the sleeve 140 causes the sleeve to bulge or expand along the length of the sleeve corresponding to the inserted ferrule 166. FIG. 16 illustrates the sleeve having non-expanded regions 136 at the first end 144 (without a ferrule/hub assembly inserted) and expanded regions 138 at the second end 146 (with a ferrule/hub assembly inserted). FIGS. 17 and 18 further illustrate the non-expanded regions 136 and expanded regions 138 of a sleeve without and with a ferrule inserted within an end. The sleeve 140 is designed such that the expanded regions 138 of the sides 148 act as springs when expanded or deformed to create centering forces to align the optic fiber 164 along the longitudinal axis B-B of the sleeve.

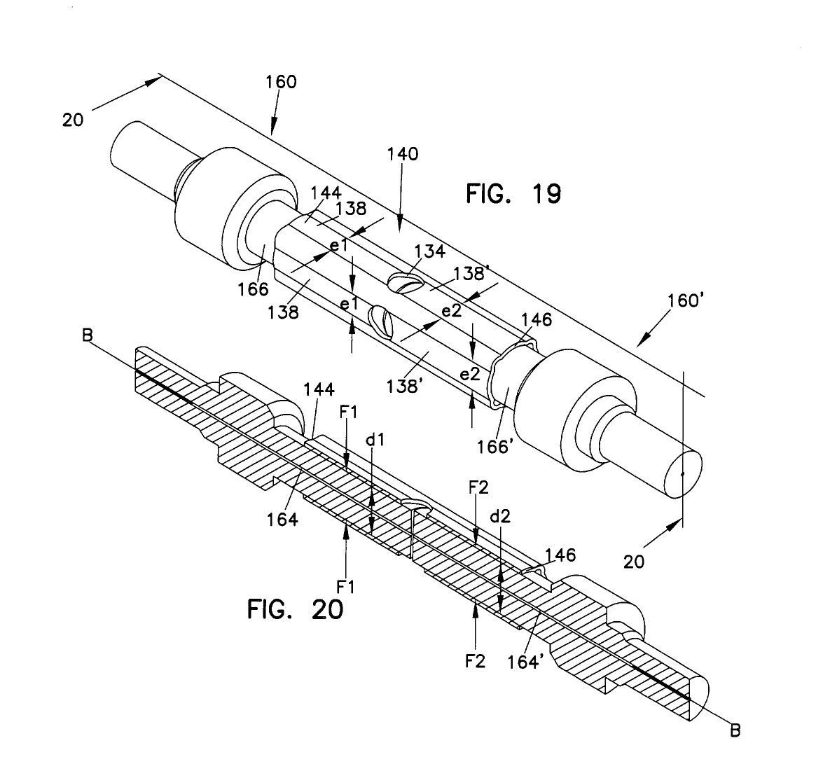

FIGS. 19 and 20 illustrate the sleeve 140 with the opening 134 assembled with cable assemblies 160, 160′ having different sized ferrules 166 and 166′. Similar to the illustration of FIG. 14, the ferrule 166 of the first ferrule/hub assembly 160 has a first dimension d1. The ferrule 166′ of a second ferrule/hub assembly 160′ has a second dimension d2. The expanded regions 138 at the first end 144 of the sleeve 140 are of a first expansion dimension e1. The second expanded regions 138′ at the second end 146 of the sleeve 140 are of a second expansion dimension e2.

Each of the expanded regions 138 at the first end 144 provide equal and opposite forces F1 (only one opposing set of forces F1 shown). The forces F1 act on the ferrule 166 to center the optic fiber 164 of the ferrule/hub assembly 160 along the sleeve's longitudinal axis B-B. Each of the expanded regions 138′ at the second end 146 provide equal and opposite forces F2 that act on the ferrule 166′ to center the optic fiber 164′ of the ferrule/hub assembly 160′ along the sleeve's longitudinal axis B-B. As can be understood, the first radial forces F1 acting on the ferrule 166 having the first dimension d1 will be of a different magnitude than the second radial forces F2 acting on the ferrule 166′ having the second dimension d2. However, because each of the expanded regions 138, 138′ of the sleeve 140 are equal and act in opposite directions toward the center longitudinal axis B-B, the cable assemblies 160, 160′, the optic fibers 164, 164′ of each ferrule/hub assembly will be aligned with one another.

As previously discussed, the sleeve 140 may take the form of other cross-sectional shapes, such as three-sided, or five-sided, or other shapes. Planar walls of these shapes, while not providing oppositely directed forces, will direct equal centering forces toward the longitudinal axis of the sleeve. It is further contemplated that one embodiment may include a cylindrical exterior surface while configured to provide the plurality of planar surfaces along the central passage of the sleeve to provide equal centering forces.

The sleeve 140 of the present disclosure also provides advantages in manufacture as the sleeve 140 maintains its orientation within an adapter assembly. Specifically, where conventional cylindrical sleeves can rotate within an adapter, the square configuration of the present arrangement prevents unwanted rotation. The present arrangement also addresses the problem of ensuring a split is not oriented in a position where the sleeve will be effected by bending forces caused by the ferrule acting as a lever arm. Because the present sleeve does not have a split, and the cross-section is generally symmetrical, orientation of the sleeve is not critical and provides ease of use and assembly.

The sleeve 140 of the present disclosure may be manufactured from materials known to those skilled in the art, ranging from phosphor-bronze to ceramics, for example. The sleeve's geometry, in accordance with the present disclosure, aids in the manufacturability by eliminating some of the need for tight machine tolerances while increasing optic fiber alignment performance.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. An adapter for holding first and second fiber optic connectors in alignment, the adapter comprising:
(a) a main body having a cavity extending between first and second ends along an axial direction;
(b) a first mating arrangement positioned at the first end of the main body, the first mating arrangement including:
(i) a first receiving portion having a first passage extending in the axial direction, the first receiving portion configured to receive the first fiber optic connector;
(c) a second mating arrangement positioned at the second end of the main body, the second mating arrangement including:
(i) a second receiving portion having a second passage extending in the axial direction, the second receiving portion configured to receive the second fiber optic connector; and
(d) a sleeve having a longitudinal axis aligned with the axial direction of the main body, the sleeve including:
(i) a sleeve body having a length defined between a first sleeve end and a second sleeve end;
(ii) the first sleeve end positioned within an inner end of the first passage of the first receiving portion;
(iii) the second sleeve end positioned within an inner end of the second passage of the second receiving portion;
(iv) wherein the sleeve includes a plurality of planar walls extending parallel to the longitudinal axis.

2. The adapter of claim 1, wherein:
(a) the sleeve has a continuous cross-section extending along the length of the of sleeve body.

3. The adapter of claim 2, wherein:
(a) the sleeve includes:
i) first and second wall structures that apply first and second forces in opposite directions;
ii) third and fourth wall structures that apply third and fourth forces in opposite directions, the third and fourth forces being directed generally orthogonal to the first and second forces.

4. The adapter of claim 3, wherein:
(a) each of the first, second, third, and fourth wall structures provide substantially equivalent forces to center the first and second fiber optic connectors along the longitudinal axis of the sleeve.

5. The adapter of claim 1, wherein:
a) the sleeve body is a continuous, non-split sleeve body.

6. The telecommunications connector assembly of claim 1, wherein:
a) each one of the plurality of planar walls provides a centering force to align an optic fiber of the first fiber optic connecter with an optic fiber of the second fiber optic connector.

7. The adapter of claim 1, wherein:
(a) the sleeve body includes four planar walls defining a square-shaped cross-section.

8. The adapter of claim 1, wherein;
(a) the sleeve further includes at least one relief opening formed in one of the plurality of planar walls.

9. The adapter of claim 8, wherein:
(a) the at least one relief opening is a hole centrally formed in the planar wall.

10. The adapter of claim 9, wherein:
(a) the at least one relief opening is a hole positioned at a midpoint of the planar wall.

11. The adapter of claim 8, wherein:
(a) the at least one relief opening is circumscribed by the planar wall.

12. The adapter of claim 1, wherein:
(a) the sleeve further includes a plurality of relief openings formed in a corresponding plurality of planar walls.

13. A method of centering a first telecommunications ferrule/hub assembly within an adapter, the method comprising:
a) providing a sleeve defining a longitudinal axis, the sleeve being assembled within an adapter configured to receive the first telecommunications ferrule/hub assembly and a second telecommunications ferrule/hub assembly, the sleeve including:
i) a plurality of planar walls; and
iii) a central passage defined by the planar walls;
b) inserting the first telecommunications ferrule/hub assembly within the central passage at a first end of the sleeve; and
c) centering the first ferrule/hub assembly along the longitudinal axis of the sleeve.

14. The method of claim 13, wherein:
a) the step of centering the first ferrule/hub assembly includes applying centering forces directed toward the longitudinal axis.

15. The method of claim 13, wherein:
a) the step of centering the first ferrule/hub assembly along the longitudinal axis of the sleeve includes contacting the first telecommunications ferrule/hub assembly at lines of contact about a circumference of the ferrule/hub assembly.

16. The method of claim 15, wherein:
a) the step of contacting the first telecommunications ferrule/hub assembly includes contacting the ferrule/hub assembly at lines of contact approximately equally spaced about the circumference of the ferrule/hub assembly.

17. The method of claim 16, wherein:
a) the step of contacting the first telecommunications ferrule/hub assembly includes contacting the first telecommunications ferrule/hub assembly at four lines of contact about the circumference of the ferrule/hub assembly.

18. The method of claim 13, including the steps of:
a) inserting a second ferrule/hub assembly within the central passage at a second end of the sleeve; and
b) centering the second ferrule/hub assembly along the longitudinal axis of the sleeve.

19. The method of claim 18, wherein:
a) the step of centering the second ferrule/hub assembly includes applying centering forces acting toward the longitudinal axis.

20. The method of claim 18, wherein:
(a) the adapter includes a first receiving portion configured for receipt of a first type of fiber optic connector, and a second receiving portion configured for receipt of a second type of fiber optic connector;
(b) the step of inserting the first telecommunications ferrule/hub assembly includes inserting the first telecommunications ferrule/hub assembly having a first type of connector; and
(c) the step of inserting the second telecommunications ferrule/hub assembly includes inserting the second telecommunications ferrule/hub assembly having a second type of connector, the second type of connector being different than the first type of connector.

21. The method of claim 20, furthering including:
(a) configuring the sleeve to axially align the second type of connector of the second ferrule/hub assembly with the first type of connector of the first ferrule/hub assembly, wherein:
(i) the first type of connector has a first connector portion inserted within the sleeve, the first connector portion having a first diameter;
(ii) the second type of connector has a second connector portion inserted within the sleeve, the second connector portion having a second diameter; and
(iii) the first diameter of the first type connector is greater than the second diameter of the second type connector.

22. The method of claim 18, wherein:
(a) the step of inserting the first telecommunications ferrule/hub assembly and the step of inserting the second telecommunications ferrule/hub assembly includes inserting first and second telecommunications ferrule/hub assemblies having a first type of connector.
